(19) United States
(12) Patent Application Publication
(10) Pub. No.: US 2013/0257875 A1
(43) Pub. Date: Oct. 3, 2013

(54) ELECTRONIC APPARATUS, METHOD OF CONTROLLING ELECTRONIC APPARATUS, AND COMPUTER-READABLE MEDIUM

(71) Applicant: KABUSHIKI KAISHA TOSHIBA, Tokyo (JP)

(72) Inventor: Toshifumi OHTAKE, Tokyo (JP)

(73) Assignee: KABUSHIKI KAISHA TOSHIBA, Tokyo (JP)

(21) Appl. No.: 13/787,053

(22) Filed: Mar. 6, 2013

(30) Foreign Application Priority Data
Mar. 27, 2012 (JP) 2012-072518

(51) Int. Cl. G08B 5/22

(52) U.S. Cl. CPC G08B 5/22
USPC 345/473

(57) ABSTRACT

In one embodiment, there is provided an electronic apparatus. The apparatus includes: a communicator configured to communicate with an external apparatus; an acquisition module configured to receive a first synchronization data from the external apparatus and to determine a time interval of the external apparatus, after association with the external apparatus; and a display module configured to display a first image and to vary the first image according to the time interval determined by the acquisition module.

### CROSS-REFERENCE TO RELATED APPLICATION

This application claims priority from Japanese Patent Application No. 2012-072518, filed on Mar. 27, 2012, the entire contents of which are hereby incorporated by reference.

### BACKGROUND

1. Field

Embodiments described herein relate to an electronic apparatus, a method of controlling the electronic apparatus, and a computer-readable medium.

2. Description of Related Art

In recent years, it has become possible for electronic apparatus to communicate with each other being connected to each other wirelessly, for example. However, this raises a problem that it is difficult to recognize a communication connection state between electronic apparatus.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention:

FIG. 1 shows how electronic apparatus A and B according to the embodiment are connected to each other;

FIG. 2 is a block diagram showing an example configuration of each of the electronic apparatus A and B;

FIGS. 3A and 3B are example timing charts for synchronizing display operations (UIs) of the electronic apparatus A and B by causing communications for synchronization between them;

FIG. 4 shows a first example of synchronized display operations of the electronic apparatus A and B;

FIG. 5 shows a second example of synchronized display operations of the electronic apparatus A and B;

FIG. 6 shows a third example of synchronized display operations of the electronic apparatus A and B;

FIG. 7 shows a fourth example of synchronized display operations of the electronic apparatus A and B;

FIGS. 8A-8C show fifth to seventh examples of synchronized display operations of the electronic apparatus A and B;

FIG. 9 is a flowchart showing how the electronic apparatus A operates; and

FIG. 10 is a flowchart showing how the electronic apparatus B operates.

### DETAILED DESCRIPTION

According to exemplary embodiments of the present invention, there is provided an electronic apparatus. The apparatus includes: a communicator configured to communicate with an external apparatus; an acquisition module configured to receive a first synchronization data from the external apparatus and to determine a time interval of the external apparatus, after association with the external apparatus; and a display module configured to display a first image and to vary the first image according to the time interval determined by the acquisition module.

An embodiment will be hereinafter described with reference to the drawings.

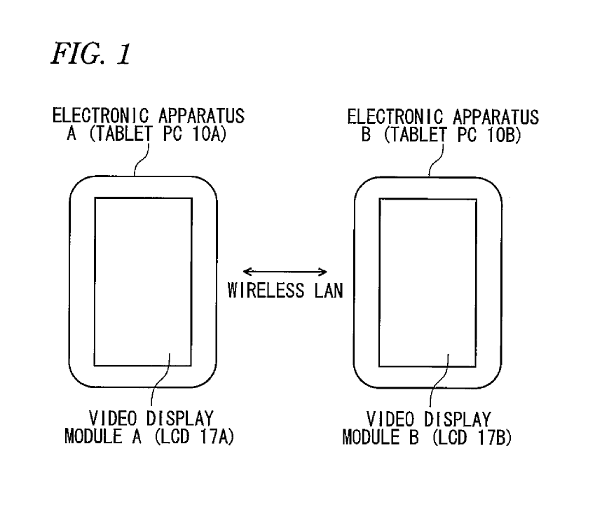

FIG. 1 shows how an electronic apparatus A (tablet PC 10A) and an electronic apparatus B (tablet PC 10B) according to the embodiment are connected to each other by a wireless LAN, for example.

The wireless LAN is a LAN system in which data is exchanged by a wireless communication, and is also called a Wave LAN or a WLAN. The wireless LAN has many types and the IEEE 802.11 series, for example, is now in wide use. The wireless LAN is used in personal computers, PDAs (personal digital assistants, personal data assistance), etc. The wireless LAN is also called Wi-Fi which is used for certification of mutual connectivity by the Wi-Fi Alliance, an industrial organization relating to IEEE 802.11 equipment.

Although in the embodiment the electronic apparatus A (10A) and B (10B) are tablet PCs, the invention is not limited to such a case and the concept of the embodiment can also be applied to notebook PCs, smartphones, cell phones, portable TV receivers, and other electronic apparatus.

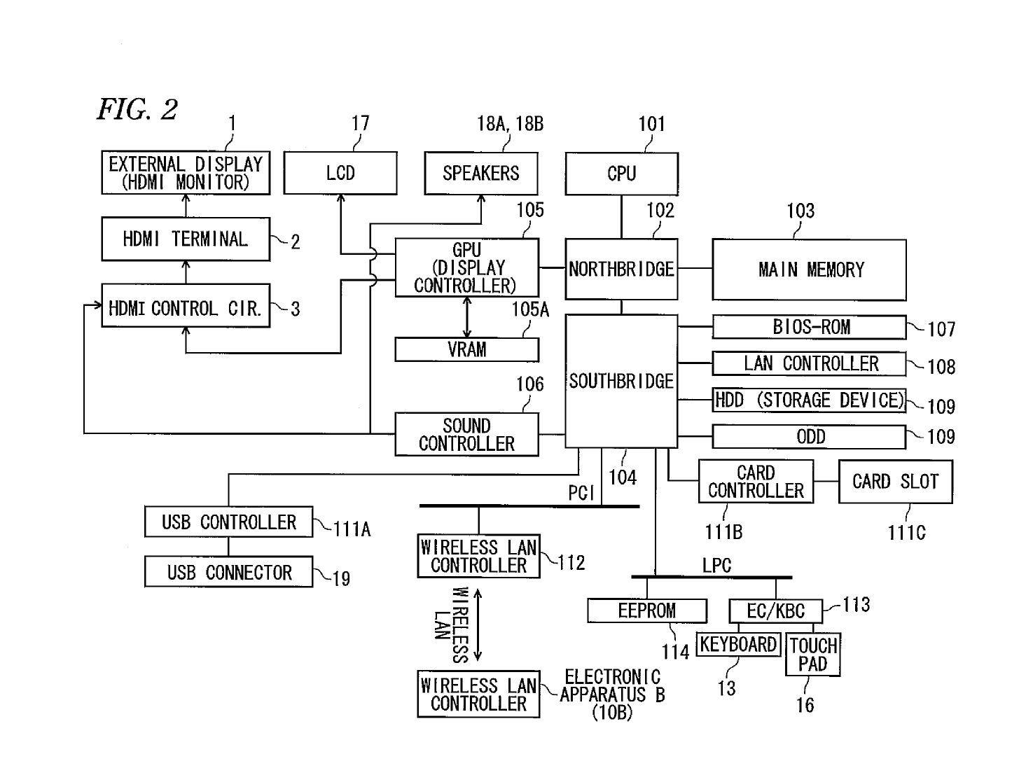

FIG. 2 is a block diagram showing an example configuration of each of the electronic apparatus A (10A) and B (10B) according to the embodiment. Each of the electronic apparatus A (10A) and B (10B) is equipped with a CPU (central processing unit) 101, a northbridge 102, a main memory 103, a southbridge 104, a GPU (graphics processing unit) 105, a VRAM (video random access memory) 105A, a sound controller 106, a BIOS-ROM (basic input/output system-read only memory) 107, a LAN (local area network) controller 108, a hard disk drive (HDD; storage device) 109, an optical disc drive (ODD) 110, a USB controller 111A, a card controller 111B, a wireless LAN controller 112, an embedded controller/keyboard controller (EC/KBC) 113, an EEPROM (electrically erasable programmable ROM) 114, etc.

The CPU 101 is a processor which controls operations of individual components of the electronic apparatus A (10A) or B (10B). The CPU 101 runs a BIOS which is stored in the BIOS-ROM 107. The BIOS is programs for hardware control.

The northbridge 102 is a bridge device which connects a local bus of the CPU 101 to the southbridge 104. The northbridge 102 incorporates a memory controller for access-controlling the main memory 103. The northbridge 102 also has a function of performing a communication with the GPU 105 via, for example, a serial bus that complies with the PCI Express standard.

The GPU 105 is a display controller which controls a display module (LCD) 17 which is used as a display monitor of the electronic apparatus A (10A) or B (10B). A display signal generated by the GPU 105 is sent to the display module (LCD) 17. The GPU 105 can also send a digital video signal to an external display 1 via an HDMI control circuit 3 and an HDMI terminal 2.

The HDMI terminal 2 is an external display connection terminal. The HDMI terminal 2 can send a non-compressed digital video signal and digital audio signal to the external display 1 such as a TV receiver via a single cable. The HDMI control circuit 3 is an interface for sending a digital video signal to the external display 1 (called an HDMI monitor) via the HDMI terminal 2.

The southbridge 104 controls the individual devices on a PCI (peripheral component interconnect) bus and the individual devices on an LPC (low pin count) bus. The southbridge 104 incorporates an IDE (integrated drive electronics) controller for controlling the HDD 109 and the ODD 110. The southbridge 104 also has a function of performing a communication with the sound controller 106.

The sound controller 106 is a sound source device, and outputs audio data, which is to be played, to speakers 18A and 18B or the HDMI control circuit 3. The LAN controller 108 is a wired communication device which performs a wired communication according to the IEEE 802.3 standard, for example. On the other hand, the wireless LAN controller 112 is a wireless communication device which performs a wireless communication according to the IEEE 802.11g standard, for example.

The USB controller 111A performs a communication with an external device (connected to it via a USB connector 19) which complies with the USB 2.0 standard, for example. For example, the USB controller 111A is used for receiving an image data file from a digital camera. The card controller 111B writes and reads data to and from a memory card such as an SD card that is inserted in a card slot that is formed in a computer main body of the electronic apparatus A (10A) or B (10B).

The EC/KBC 113 is a one-chip microcomputer in which an embedded controller for power management and a keyboard controller for controlling the keyboard 13 and the touch pad 16 are integrated together. The EC/KBC 113 has a function of powering on or off the electronic apparatus A (10A) or B (10B) in response to a user manipulation of a power button.

In the embodiment, a display control is performed in such a manner that, for example, the CPU 101 runs programs stored in the main memory 103, the HDD 109, etc. The above configuration of each of the electronic apparatus A (10A) and B (10B) is just an example, and each of the electronic apparatus A (10A) and B (10B) may have hardware whose configuration is different from the above-described one.

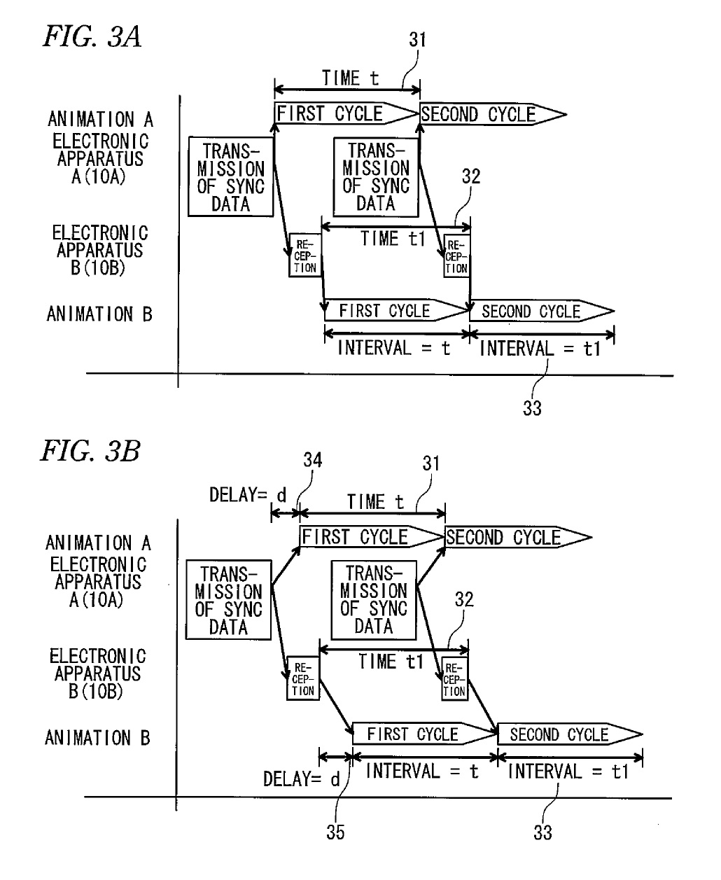

FIGS. 3A and 3B are example timing charts for synchronizing UI (user interface) display operations of the electronic apparatus A (10A) and B (10B) according to the embodiment by causing communications for synchronization between them.

In the embodiment, as described later, a connection state between the electronic apparatus A (10A) and B (10B) according to the embodiment is displayed so as to be recognized intuitively by synchronizing UIs, animations, or the like to be displayed on them.

In the embodiment, NFC (near field communication) is employed as an example method for a wireless LAN connection. The NFC is short-range wireless communication whose communication range is as short as several centimeters to about 1 m, for example. The NFC is equivalent to non-contact communication which includes FeliCa, ISO/IEC 14443 (MIFARE), ISO/IEC 18092, etc.

In the embodiment, when the electronic apparatus A (10A) and the electronic apparatus B (10B) have been rendered in an NFC communication state, they can exchange data in real time. Therefore, UI display operations of the electronic apparatus A (10A) and B (10B) can be synchronized with each other by, for example, causing communications for synchronization regularly.

FIG. 3A is a timing chart showing example communications for synchronization which are performed in the embodiment. In the embodiment, as shown in FIG. 3A, the electronic apparatus A (10A) displays a preset UI or animation A on the video display module A (LCD 17A) in such a manner that it varies during each interval of a time t (31), that is, in a first cycle, a second cycle, and so forth. For example, as described later, as variable display, the preset UI or animation A is displayed steadily, flashed, or moved. The preset UI or animation and the time t are stored in the EEPROM 114 in advance.

The electronic apparatus A (10A) sends sync data to the electronic apparatus B (10B) successively at the starts of the first-cycle display, the second-cycle display, etc. The electronic apparatus B (10B) receives the first-cycle sync data and the second-cycle sync data that are transmitted from the electronic apparatus A (10A) and acquires, as an interval, a time difference t1 (32) between them.

As in the electronic apparatus A (10A), the electronic apparatus B (10B) displays a preset UI or animation B (stored in an EEPROM or the like) as in the electronic apparatus A (10A) on a video display module B (LCD 17B) in such a manner that it varies for the time t (31) in the first cycle and varies during the acquired interval (for the time difference t1 (32) between the sync data) in the second cycle.

That is, the electronic apparatus B (10B) (sync data reception side) measures a difference t1 (32) between sync data arrival times and uses the measured time t1 (32) as the interval of the next animation display. The time difference t1 (32) is updated every time new sync data is received. Alternatively, time differences t1 (32) acquired so far are added up and averaged.

Example communications shown in FIG. 3B are different than shown in FIG. 3A in that the electronic apparatus A (10A) displays the animation A after a delay time d (34) from the start of the first-cycle interval which lasts the time t (31). Likewise, the electronic apparatus B (10B) displays the animation B after the delay time d (35) from the start of the first-cycle interval which lasts the time t (31). This measure presents an event that the electronic apparatus A (10A) fails to display part of the animation A in the first cycle or the electronic apparatus B (10B) fails to display part of the animation B in the first cycle.

As described above, in the embodiment, the electronic apparatus A (10A) and B (10B) perform communications for synchronization, whereby their UI display operations are synchronized with each other.

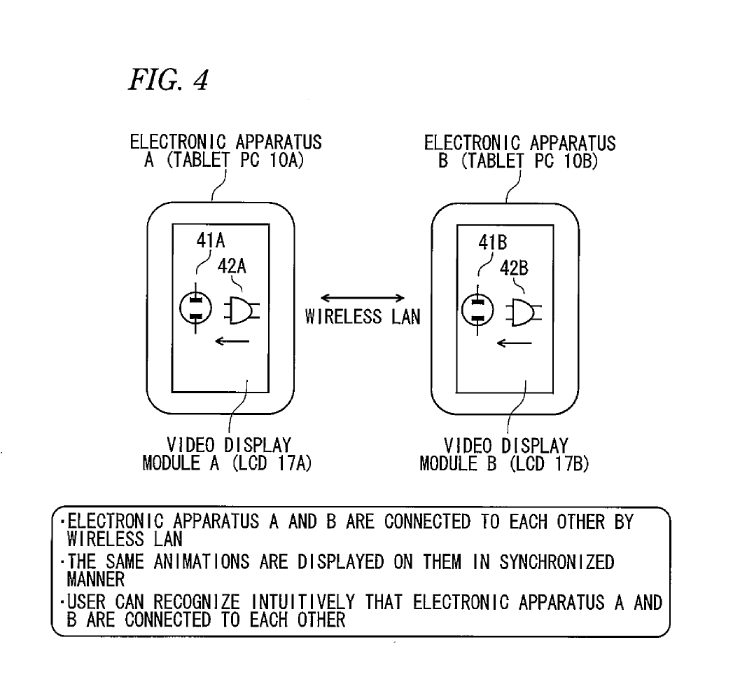

FIG. 4 shows a first example of synchronized display operations of the electronic apparatus A (10A) and B (10B) according to the embodiment.

In this example, the same images are displayed on the video display module A (17A) of the electronic apparatus A (10A) and the video display module B (17B) of the electronic apparatus B (10B) in a synchronized manner. More specifically, an animation that a terminal 42A is moved leftward so as to approach a plug 41A is displayed on the video display module A (17A). And an animation that a terminal 42B is moved leftward so as to approach a plug 41B is displayed on the video display module B (17B) so as to be synchronized with the animation that is displayed on the video display module A (17A) of the electronic apparatus A (10A) which is wirelessly connected to the electronic apparatus B (10B).

In this example, as described above, the electronic apparatus A (10A) and the electronic apparatus B (10B) are connected to each other by the wireless LAN. The same animations are displayed on the electronic apparatus A (10A) and the electronic apparatus B (10B) in a synchronized manner. Thus, the user can recognize intuitively that the electronic apparatus A (10A) and the electronic apparatus B (10B) are connected to each other.

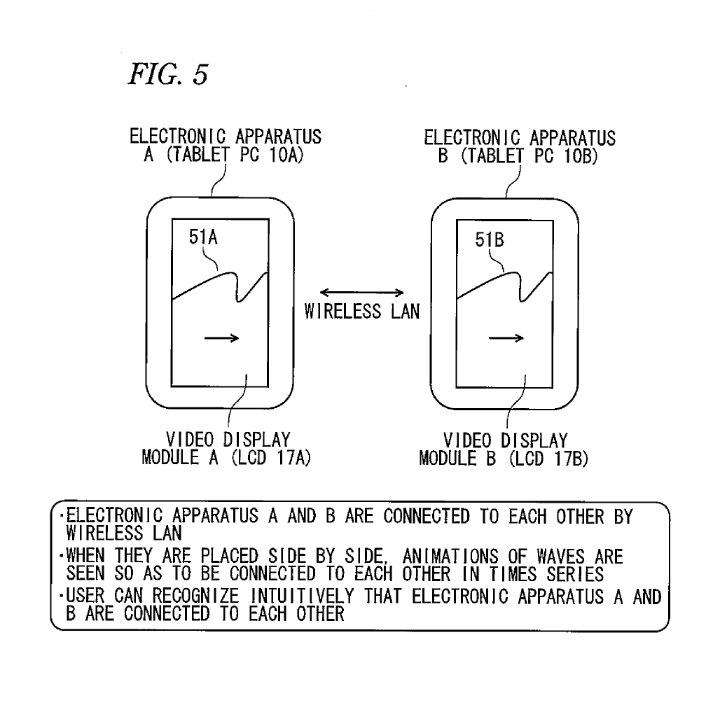

FIG. 5 shows a second example of synchronized display operations of the electronic apparatus A (10A) and B (10B) according to the embodiment.

In this example, the same images are displayed on the video display module A (17A) of the electronic apparatus A (10A) and the video display module B (17B) of the electronic apparatus B (10B) in a synchronized manner. More specifically, an animation that a wave 51A is moved rightward is displayed on the video display module A (17A). And an animation that a wave 51B is moved rightward is displayed on the video display module B (17B) so as to be synchronized with the animation that is displayed on the video display module A (17A) of the electronic apparatus A (10A) which is wirelessly connected to the electronic apparatus B (10B).

In this example, as described above, the electronic apparatus A (10A) and the electronic apparatus B (10B) are connected to each other by the wireless LAN. The same animations are displayed on the electronic apparatus A (10A) and the electronic apparatus B (10B) in a synchronized manner. When the video display module A (17A) of the electronic apparatus A (10A) are placed side by side, the animations of the waves 51A and 51B are seen so as to be connected to each other in time series. Thus, the user can recognize intuitively that the electronic apparatus A (10A) and the electronic apparatus B (10B) are connected to each other.

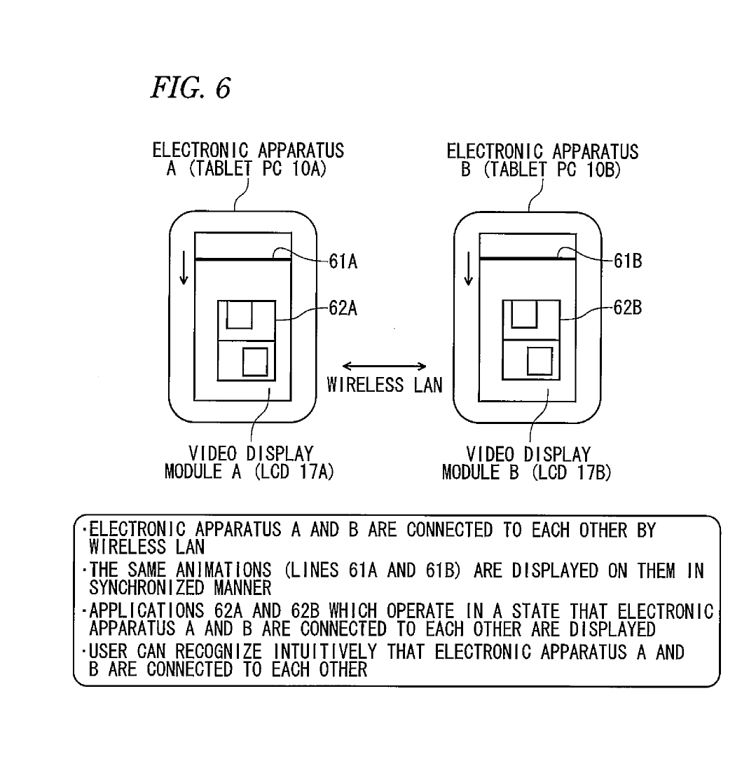

FIG. 6 shows a third example of synchronized display operations of the electronic apparatus A (10A) and B (10B) according to the embodiment.

In this example, the same images are displayed on the video display module A (17A) of the electronic apparatus A (10A) and the video display module B (17B) of the electronic apparatus B (10B) in a synchronized manner. More specifically, the same animations (lines 61A and 61B) are displayed on the backgrounds of the display screens of the video display modules A and B (17A and 17B) so as to be moved in a synchronized manner. Furthermore, applications 62A and 62B which operate in a state that the electronic apparatus A (10A) and the electronic apparatus B (10B) are connected to each other are displayed on the respective display modules A and B (17A and 17B).

In this example, as described above, the electronic apparatus A (10A) and the electronic apparatus B (10B) are connected to each other by the wireless LAN. By virtue of the synchronized display of the animations (lines 61A and 618) and the display of the applications 62A and 62B, the user can recognize intuitively that the electronic apparatus A (10A) and the electronic apparatus B (10B) are connected to each other.

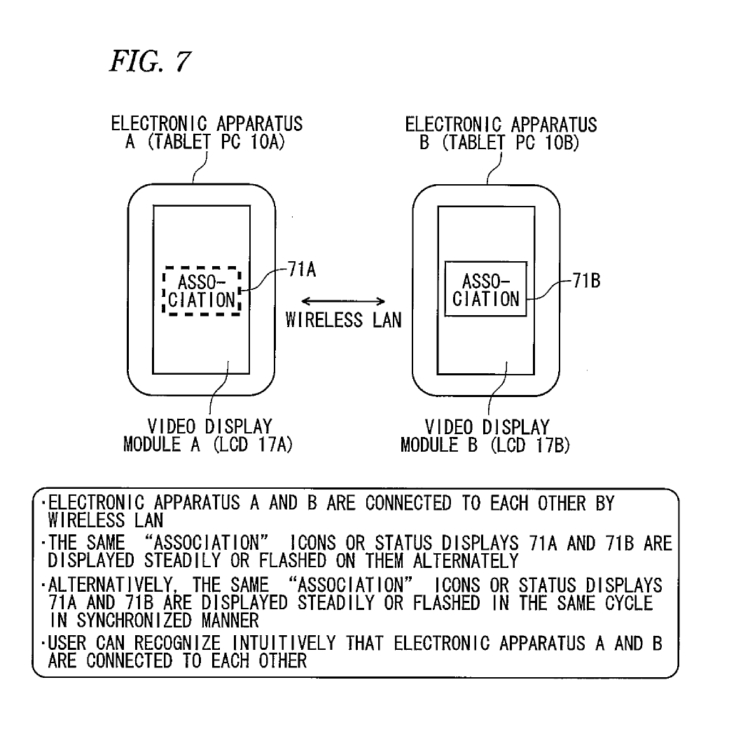

FIG. 7 shows a fourth example of synchronized display operations of the electronic apparatus A (10A) and B (10B) according to the embodiment.

In this example, the same images are displayed alternately on the video display module A (17A) of the electronic apparatus A (10A) and the video display module B (17B) of the electronic apparatus B (10B). More specifically, the same “association” icons or status displays 71A and 71B are displayed steadily or flashed alternately on the video display modules A and B (17A and 17B).

In this example, as described above, the electronic apparatus A (10A) and the electronic apparatus B (10B) are connected to each other by the wireless LAN. The same animations, that is, the “association” icons or status displays 71A and 71B, are displayed steadily or flashed alternately on the electronic apparatus A (10A) and the electronic apparatus B (10B). Alternatively, the “association” icons or status displays 71A and 71B may be displayed steadily or flashed in the same cycle in a synchronized manner. Thus, the user can recognize intuitively that the electronic apparatus A (10A) and the electronic apparatus B (10B) are connected to each other.

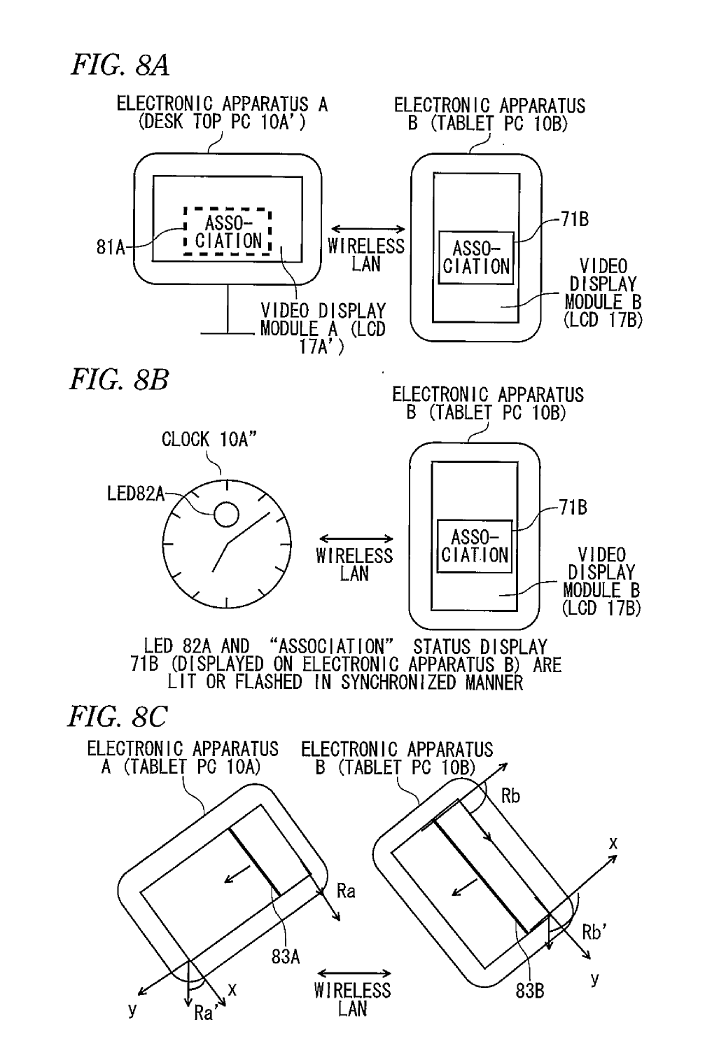

FIGS. 8A-8C show other examples of synchronized display operations of the electronic apparatus A and B according to the embodiment.

FIG. 8A shows a fifth example of synchronized display operations of the electronic apparatus A (desk top PC 10A′) and the electronic apparatus B (tablet PC 10B) according to the embodiment. In this example, as in the example of FIG. 7, the same images are displayed alternately on the video display module A (LCD 17A′) of the electronic apparatus A (desk top PC 10A′) and the video display module B (LCD 17B) of the electronic apparatus B (10B). As a result, the user can recognize intuitively that the electronic apparatus A (10A′) and the electronic apparatus B (10B) are connected to each other.

FIG. 8B shows a sixth example of synchronized display operations of the electronic apparatus A (clock 10A″) and the electronic apparatus B (tablet PC 10B) according to the embodiment. In this example, an LED 82A is used a display module of the electronic apparatus A (clock 10″). The display module (LED 82A) of the electronic apparatus A (clock 10A″) and a “association” status display 71B (displayed on the video display module B (LCD 17B) of the electronic apparatus B (10B)) are lit or flashed in a synchronized manner. As a result, the user can recognize intuitively that the electronic apparatus A (10A″) and the electronic apparatus B (10B) are connected to each other.

FIG. 8C shows a seventh example of synchronized display operations of the electronic apparatus A (tablet PC 10A) and the electronic apparatus B (tablet PC 10B) according to the embodiment.

In this example, posture information (a rotation angle of an animation) of the electronic apparatus A (tablet PC 10A) is transmitted form the tablet PC 10A to the tablet PC 10B as part of sync data (described above with reference to the timing chart 3A or 3B), whereby animations are displayed on the two tablet PCs 10A and 10B in a synchronized manner according to their postures.

A method for calculating a rotation angle of an animation in this example will be described below. The X axis and the Y axis are defined on the surface of each of the tablet PCs 10A and 1013, and x and y components of the gravity vector are detected using the X axis and the Y axis.

A screen rotation angle is judged on the basis of the detected x and y components. An image is rotated in the tablet PC 10B so as to be seen in the same manner as on the table PC 10A. In FIG. 8C, symbol Ra represents an image rotation angle of the table PC 10A, Ra′ represents a rotation angle correction value calculated from the gravity vector of the table PC 10A, Rb represents an image rotation angle of the table PC 10B, and Rb' represents a rotation angle correction value calculated from the gravity vector of the table PC 10A. Ra is equal to 0 and Rb is equal to Rb′+Ra′.

Modifications to this example are conceivable in which the Z axis of an acceleration sensor is used or synchronization is taken three-dimensionally using a compass.

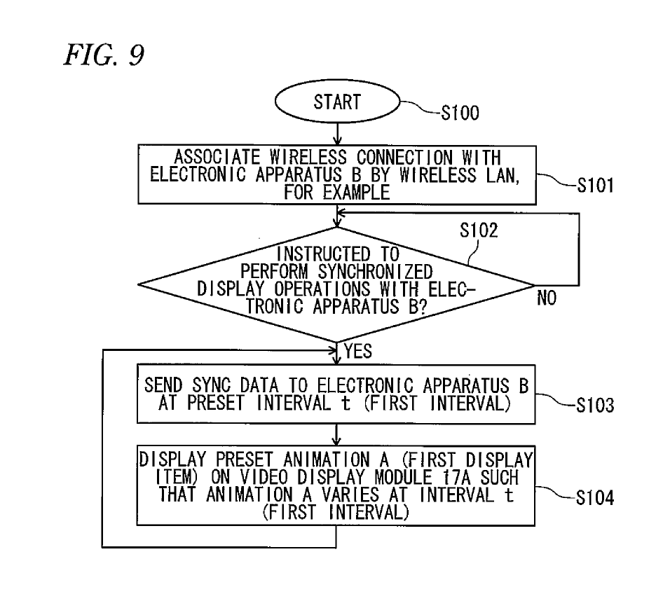

FIG. 9 is a flowchart showing how the electronic apparatus A (10A) according to the embodiment operates.

The process starts at step S100. At step S101, the electronic apparatus A associates a wireless connection with the electronic apparatus B by a wireless LAN, for example.

At step S102, the electronic apparatus A determines whether or not it has been instructed to perform synchronized display operations with the electronic apparatus B. If the electronic apparatus A determines that it has been instructed to perform synchronized display operations with the electronic apparatus B (S 102: Yes), the process moves to step S103. If not (S102: No), step S102 is executed again.

At step S103, the electronic apparatus A sends sync data to the electronic apparatus B at a preset interval t (first interval).

At step S104, the electronic apparatus A displays a preset animation A (first display item) on the video display module 17A in such a manner that it varies during the interval t (first interval). For example, as described above, the preset animation A is displayed steadily, flashed, or moved. Then, the process returns to step S103.

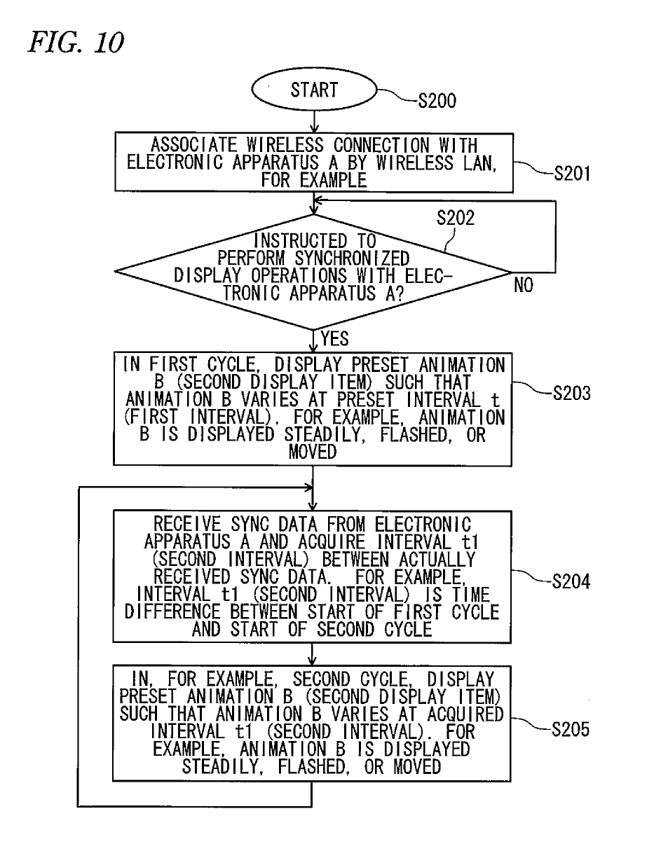

FIG. 10 is a flowchart showing how the electronic apparatus B (10B) according to the embodiment operates.

The process starts at step S200. At step S201, the electronic apparatus B associates a wireless connection with the electronic apparatus A by a wireless LAN, for example.

At step S202, the electronic apparatus B determines whether or not it has been instructed to perform synchronized display operations with the electronic apparatus A. If the electronic apparatus B determines that it has been instructed to perform synchronized display operations with the electronic apparatus A (S202: Yes), the process moves to step S203. If not (S202: No), step S202 is executed again.

At step S203, in the first cycle, the electronic apparatus B displays a preset animation B (second display item) on the video display module 17B in such a manner that it varies during a preset interval t (first interval). For example, as described above, the preset animation B is displayed steadily, flashed, or moved.

At step S204, the electronic apparatus B receives sync data that is transmitted from the electronic apparatus A and acquires an interval t1 (second interval) between actually received sync data. For example, the interval t1 (second interval) is a time difference between the start of the first cycle and the start of the second cycle.

At step S205, in, for example, the second cycle, the electronic apparatus B displays the preset animation B (second display item) on the video display module 17B in such a manner that it varies during the acquired interval t1 (second interval). For example, as described above, the preset animation B is displayed steadily, flashed, or moved. Then, the process returns to step S204.

According to the embodiment, the electronic apparatus B (10B) is equipped with a communicator (wireless LAN controller 112) capable of associating a communication connection with an external apparatus (electronic apparatus A (10A)); an acquisition module (CPU 101) for receiving sync data from the external apparatus when receiving a display instruction to perform synchronized display operations with the external apparatus, and for acquiring, as an interval, a time difference between received sync data; and a display module (video display module B (17B)) for displaying a preset display item in such a manner that it varies during the acquired interval.

The display module displays the preset display item in such a manner that it varies during the acquired interval after displaying the preset display item in such a manner that it varies during a preset interval.

Alternatively, the display module displays the preset display item in such a manner that it varies during the preset interval after a lapse of a preset delay time from the reception of sync data.

The display of the preset display item on the electronic apparatus is substantially timed to display, on the external apparatus, of a display item that is preset in the external apparatus.

The display of the preset display item on the electronic apparatus and display, on the external apparatus, of a display item that is preset in the external apparatus are performed substantially alternately.

With the above configurations, the embodiment makes it possible to allow a user to recognize a communication connection state between electronic apparatus intuitively.

All the steps of each control process according to the embodiment can be implemented by software. Therefore, the advantages of the embodiment can easily be obtained merely by installing programs of the control processes in an ordinary computer via a computer-readable storage medium that is stored with those programs and running the installed programs.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. An electronic apparatus comprising:
a communicator configured to communicate with an external apparatus;
an acquisition module configured to receive a first synchronization data from the external apparatus and to determine a time interval of the external apparatus, after association with the external apparatus; and
a display module configured to display a first image and to vary the first image according to the time interval determined by the acquisition module.

2. The apparatus according to claim 1, wherein
the display module is further configured to display the first image such that the first image varies at a preset time interval prior to displaying the first image such that the first image varies at the determined time interval.

3. The apparatus according to claim 2, wherein the display module is further configured to display the first image such that the first image varies at the determined time interval after a delay time has lapsed.

4. The apparatus according to claim 1, wherein the electronic apparatus and the external apparatus are configured to display an image at the substantially same time.

5. The electronic apparatus according to claim 1, wherein the electronic apparatus and the external apparatus are configured to display an image alternately.

6. A method of controlling an electronic apparatus, the method comprising:
(a) receiving a first synchronization data from an external apparatus configured to communicate with the electronic apparatus;
(b) determining a time interval of the external apparatus after association with the external apparatus; and
(c) displaying a first image and varying the first image according to the determined time interval.

7. A computer-readable medium storing a program for causing the computer to perform operations comprising:
(a) receiving a first synchronization data from an external apparatus configured to communicate with the electronic apparatus;
(b) determining a time interval of the external apparatus after association with the external apparatus; and
(c) displaying a first image and varying the first image according to the determined time interval.
